(19) United States
(12) Patent Application Publication
(10) Pub. No.: US 2002/0004133 A1
(43) Pub. Date: Jan. 10, 2002

(54) Paint mask

(76) Inventor: Nasser Nakib, New York, NY (US)

Correspondence Address: DARBY & DARBY P.C., 805 Third Avenue, New York, NY, 10022, US

(21) Appl. No.: 09/792,274

(22) Filed: Feb. 23, 2001

Related U.S. Application Data
(60) Provisional application No. 60/184,370, filed on Feb. 23, 2000.

(51) Int. Cl. B32B 7/12; B32B 15/04

(52) U.S. Cl. 428/343; 428/354

(57) ABSTRACT

A product for protecting household surfaces, such as a windowpane, doorknob or switch box, during painting or finishing which comprises a rectangular sheet of impervious material that includes four strips of light tach, pressure sensitive adhesive tape, each strip being located on a different edge of the sheet covering the span of the edge. The sheets are sized so that when applied to a windowpane or other rectangular surface, one sheet can be applied to each corner of the surface.

### FIELD OF THE INVENTION

This invention relates to masks of the type used to shield surfaces and objects during painting and other finishing procedures.

### BACKGROUND OF THE INVENTION

The need to protect surfaces during painting and other finishing operations of contiguous surfaces requires the shielding or masking of the surfaces to be protected. This is a time consuming job which requires careful attention to detail if the surface is to be fully protected.

The present invention provides a masking product which can be used with a wide variety of different surfaces. The product is extremely easy to install and easy to remove without damage to, or tarnishing of, the items being masked. As an example, when a homeowner paints its window mullions, one mask is placed on each corner of the windowpane so as to protect the pane from exposure to the paint. The masking product is simply pressed onto the pane corners, and does not require a cutting or tearing effort from the user. To supplement the masks, conventional masking tape is easily applied between gaps on the edges of the window. Thus, it requires less skill to apply and saves time as compared to existing masking procedures.

### SUMMARY OF THE INVENTION

In accordance with the invention, a pad or roll of rectangular masking sections is provided for masking the surface of an object, such as a windowpane, doorknob, switch plate, or similar household structure. The rectangular sections include adhesive material that is low tack and pressure sensitive, located on the surface of the mask that faces the object.

When the preferred embodiment is applied to a rectangular object, such as a windowpane, the mask sections are sized so that at least four individual mask sections are required to completely mask the surface. Each of the four mask sections is placed on a corner of the surface whereby conventional masking tape can be applied between the mask sections to cover any edge of the windowpane remaining exposed. The masks obviate the need to cut the tape to exact lengths or ninety degree angles.

### BRIEF DESCRIPTION OF THE DRAWINGS

FIG. 1 is a perspective view of the preferred embodiment of the invention installed on a windowpane;

FIG. 2 is a perspective view of the preferred embodiment of the invention as manufactured;

FIG. 3 is a perspective view of the preferred embodiment of the invention as installed on an escutcheon of a door handle assembly;

FIG. 4 is a perspective view of the preferred embodiment of the invention installed on a door hinge;

FIG. 5 is a perspective view of a second embodiment of the invention installed over a light switch;

FIG. 6 is a perspective view of the second embodiment of the invention as manufactured.

### DETAILED DESCRIPTION

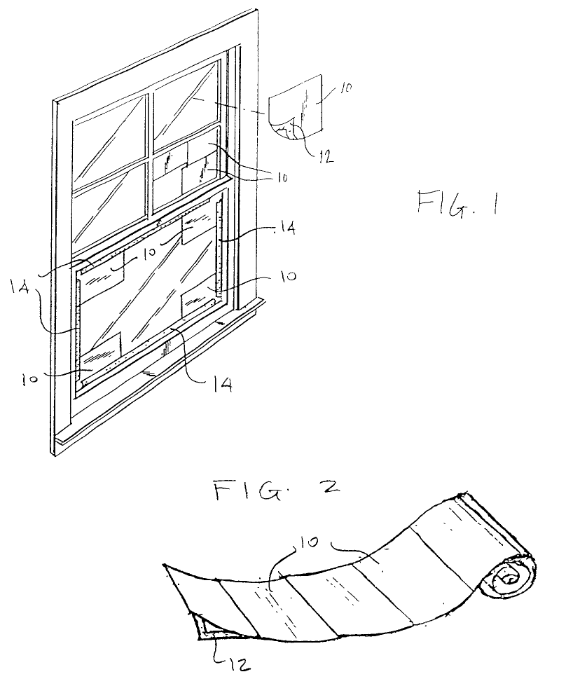

As shown in FIG. 1, a typical mask 10 in accordance with the invention is rectangular. It must be flexible and impervious to paint or similar finishing fluids, where the fluids are applied via brushing or pressure spraying. The mask 10 is made of conventional mask material with these characteristics, such as paper, plastic, or the like. The mask 10 is coated with a low tack, pressure sensitive adhesive 12 that (for example) spans three-quarters of an inch or less in width along the mask edges. It is also contemplated that the entire mask surface may be coated. A suitable adhesive 12 is POSTIT™ brand or similar removable adhesive, or one used for commercial masking tape. The adhesive 12 is applied by any one of the following methods: air spraying; electrostatic spraying; block or pressure printing; roll printing or applied double side tape application.

A typical application of the mask 10 is shown in the top window of FIG. 1 which represents a conventional mullion-style window having four panes of glass where the panes are masked while the mullions are painted. As shown in the lower right hand pane at the top of FIG. 1, it is preferable to apply four individual masks 10 to the comers of the pane of glass until the entire area is covered with the masks 10 overlapping in the center. Here each of the masks 10 is approximately four and a quarter by five and a half inches or some multiple thereof. Ordinarily, it is time consuming to mask this kind of window, but using the invention each pane is masked in just a few seconds.

If a large window is used as shown in the bottom of FIG. 1, it is preferable to place an individual mask 10 at each of the corners with conventional masking tape 14 extending between the masks 10. If only standard masking tape was applied, custom ninety degree cutting of the tape would be required at the location of the window. Without the masks 10, only custom cutting of the masking tape can guarantee the protection of the pane corners from exposure to paint or finishing substances. Because the masks 10 protect the comers, it is not necessary to cut the masking tape to precise dimensions so that the user can spend more time painting and less time protecting the pane.

The mask 10 tightly engages the window with the edges of the mask 10 abutted against the putty, caulk or muller trim holding the pane to the frame of the window. It is preferred that the pane be clean before applying the mask 10. A roller may be used to dislodge air bubbles trapped between the mask 10 and the pane. Due to the adhesive 12, the mask 10 seals firmly to the window. The mask 10 and any necessary masking tape receives overlapping paint or finishing fluid while the window frame receives the finishing treatment.

A set of masks 10 can be provided in any fashion but it is preferred to provide the set in pads or in rolls. A pad set would be similar to the well known POSTIT™ pads where a set of masks 10 are brought into superposed positions and secured together by application of the low tack adhesive 12. In this embodiment, each mask 10 is simply peeled from the pad and applied to a surface. If preferred, a backing sheet (not shown) may be applied that contains the low tack adhesive 12 on a single edge of the sheet. Thus, the set of masks 10 would be secured together at one edge rather than at each edge, reducing the effort required to remove a single mask 10.

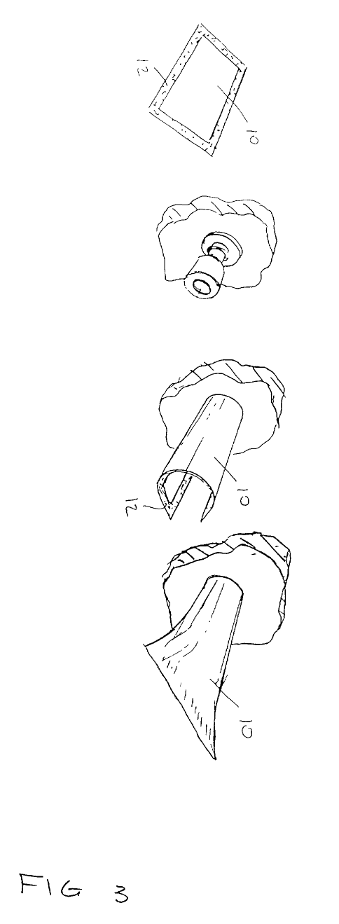

As shown in FIG. 2, if the masks 10 are provided in a roll, they are separated by score lines which provide for easy separation of the masks. The low tack adhesive 12 allows for rolling the masks 10 on themselves. If preferred, the masks 10 may be mounted on a backing sheet and the combined masks 10 and backing sheet formed into the roll. A simple dispensing device for the roll can be used to facilitate the dispensing and separation of individual masks 10.

As shown in FIG. 3, a mask 10 according to the invention also protects doorknobs and the like. In this case, an adhesive edge 12 of a mask 10 is wrapped around an escutcheon which is secured to the door in a conventional fashion. More than one mask 10 is used where the mask 10 does not wrap completely around the escutcheon. After the doorknob is wrapped, the open ends of the mask 10 are pressed shut to protect the doorknob. Once masked, the door is painted or finished quickly and easily, either by a brush or spray about the escutcheon. The mask 10 assures that the finishing fluids will not reach the metal of the doorknob. Here the mask 10 provides for a smooth and clean working atmosphere that does not require protecting the doorknob with time consuming techniques such as masking tape or the like.

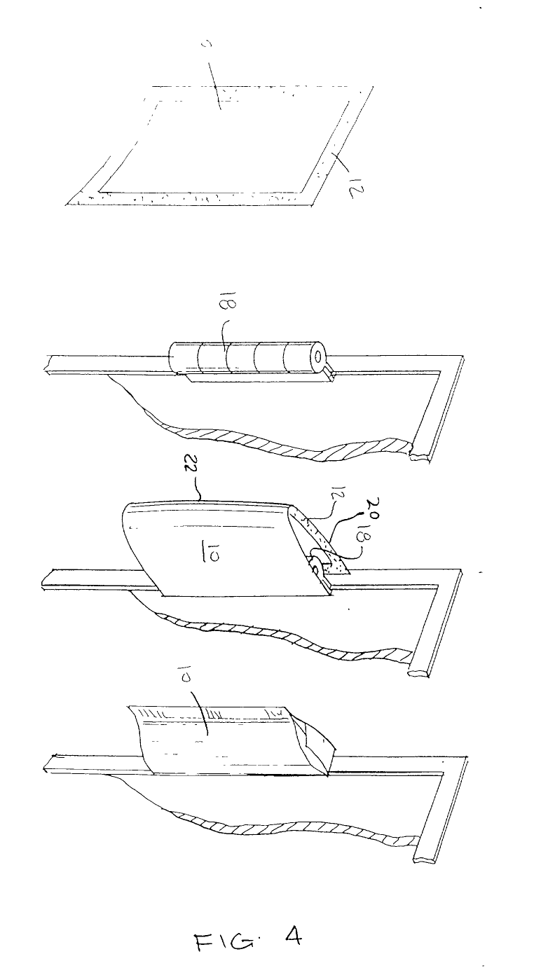

The masks 10 also protect conventional hinges 18 used to hang a normal-sized building door or cabinet door, as shown in FIG. 4. In this case, the mask 10 is folded over the hinge 18, and the ends are pinched together over the butt plates to protect the hinge cylinder and cylinder pin. In use, the mask 10 is applied to the door hinge 18 such that the adhesive 12 engages the butt plates. The adhesive 12 secures the mask 10 while the low tack aspect enables adjusting the mask 10 without removal from the butt plates. Thus the user achieves precise placement of the mask 10 with the butt plates.

The mask 10 is properly placed with the butt plates when the straight top edge of the mask 20 aligns with the top edge of the door and the intermediate region of the mask 22 is concomitantly in juxtaposition with the hinge cylinders, as shown in FIG. 4. At this point, the mask 10 achieves maximum protection against paint on the hinge structure 18. The top and bottom surface of the hinge pin and cylinder are protected from paint or other finishing liquid when the respective adhesive edges of the mask 10 are pressed together. Moreover, since the edges of the mask 10 are not in contact with the hinge cylinder, the mask 10 does not restrict movement of the door. When masks 10 are applied to the hinge 18 on both the door jamb section of the door and the outer section of the door, paint may be applied to all parts of the door and door jamb without the need for removal of the door from the frame, saving time and energy.

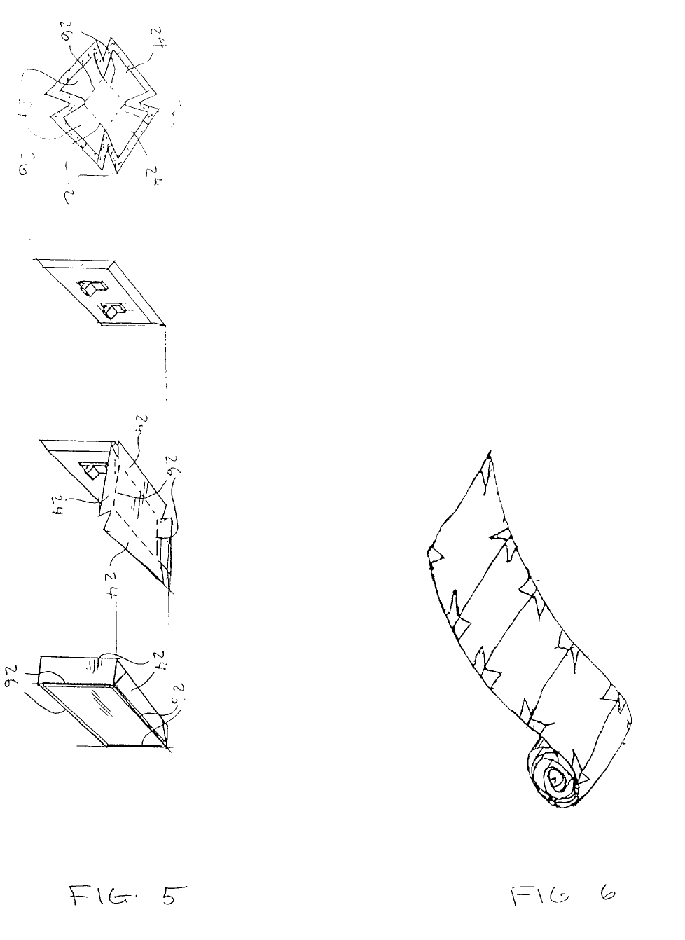

FIG. 5 shows a further embodiment of a mask 10 in accordance with the invention. In this embodiment, the acute comer angles in the mask 10 enable use with various sized wall plates having different edge bevels. To apply the mask 10, one of four flaps 24 folds along a fold line 26, and adheres to the upper edge as shown in FIG. 5. The comer angles then fold over the adjacent edges where the adhesive 12 enables adhering between the flaps. The same procedure is followed for each of the two sides and the bottom edge which create a three dimensional box around the plate. The masks 10 are provided in a roll as shown in FIG. 6. Alternatively, the masks 10 are provided in pads, as described above.

These box-like enclosures are used to mask three dimensional objects such as electrical outlets, switches and thermostats. By forming a three dimensional enclosure, it is possible to mask items such as switches in which there are protruding parts. The mask 10 can be provided in standard sizes to accommodate architectural items of conventional size. When the cover is in place, it is obvious that paint or finishing fluid will neither soil the object, such as an outlet, switch, or thermostat, nor the electrical wires connected to the object.

What is claimed is:

1. A product for protecting a surface during a finishing process, comprising:
a first planar material that is flexible and impervious to the finishing process; the first material is dimensioned so that not less than four sheets of the first material cover a surface that is rectangular and planar; and the first material has an adhesive coating located on one side of the first material for temporarily holding the material to the surface.

2. The product of claim 1, where the adhesive substance is low tack and pressure sensitive.

3. The product of claim 1, provided in the form of a pad.

4. The product of claim 1, provided in the form of a roll wherein the material contains score cuts at strategic locations for separating sheets of the material from the roll.

5. The product of claim 1, comprising acute comer angles located at the corners of the first material and whereby the first material is folded about the comer angles and applied to a beveled switch box, outlet or thermostat.

6. The product of claim 1, including a backing sheet removably attached to the adhesive material.

7. The product of claim 1, further including a second material for connecting the edges of the first material wherein:
the second material is flexible and impervious to the finishing process, and contains a strip of tow tach, pressure sensitive adhesive on one side; and the second material is selectively, placed on the rectangular surface, between the edges of the first material.
